(19) United States
(12) Patent Application Publication
(10) Pub. No.: US 2007/0051491 A1
(43) Pub. Date: Mar. 8, 2007

(54) No-idle heating and cooling system for vehicles

(76) Inventors: Alex Moultanovsky, Mishawaka, IN (US); Casey Cummings, Canton, TX (US); Jorge Aguilar, Elkhart, IN (US)

Correspondence Address: Ryan M. Fountain, Esq., 420 Lincoln Way West, Mishawaka, IN, 46544, US

(21) Appl. No.: 11/219,991

(22) Filed: Sep. 6, 2005

(51) Int. Cl. B60H 3/00

(52) U.S. Cl. 165/42

(57) ABSTRACT

An auxiliary heating and cooling system for vehicles is provided wherein there are two alternative sources of primary thermal fluid, one being driven by the vehicle engine and the other by an electrical source separate from the vehicle, but both using the same secondary thermal fluid, operable under a lower pressure and being water based. Each of the primary fluids is alternatively connectable to a heat exchanger receiving the secondary fluid. The secondary fluid is connected to one or more fluid to air heat exchangers spaced as desired in the passenger compartment and to any internal container or constant temperature box heat exchangers, such as a refrigerator, as desired within the compartment. This invention permits use of modular components mounted from the exterior of the vehicle. Various fluid flow directional valves can be used as desired for flexibility in temperature orientation.

### BACKGROUND AND SUMMARY OF THE INVENTION

The present invention relates generally to heating and cooling of vehicles, and, more particularly, to heating and cooling of internal combustion engine driven vehicles when the vehicle is not in motion.

Previously, when vehicles, such as trucks, ambulances and busses have been parked overnight or for extended periods of time with occupants present it has been necessary to maintain a comfortable interior environment, such as by heating and cooling the cab or compartment of the vehicle, according to the exterior environment. Typically, the primary vehicle engine or a smaller secondary engine has been used by running it at idle to provide the source of thermal fluid and power for this function.

However, running an internal combustion engine of any size for this purpose has certain disadvantages, including excessive fuel costs, air pollution, noise, leakage, and maintenance costs. Alternative systems have been proposed, but those have typically been relatively difficult and expensive to install, required parallel systems (independent for heating and for cooling) and/or have taken up more interior space within the cab that is desired. Moreover, many vehicles, such as ambulances, have secondary thermal containers, such as medication refrigerators, that are placed within the occupied portions of the vehicle and require either and independent or competing thermal fluid source.

Accordingly, it is an object of the present invention to provide and improved climate control system for use in a vehicle while the vehicle is not in motion. Another object of the present invention is to provide a vehicle climate control system that:
a. integrates the heating and cooling systems during motion and when parked,
b. is streamlined in installation and relatively inexpensive to manufacture,
c. eliminates leakage of hazardous fluids into the occupied portion of the vehicle,
d. uses the vehicle engine during vehicle motion and an external power source when the vehicle is parked,
e. is quiet and reliable during operation when the vehicle is parked,
f. integrates all thermal needs of the vehicle for passengers and compartment accessories, and
g. is inexpensive to operate, service and maintain.

These and other objects of the present invention are obtained by the provision of an auxiliary heating and cooling system for vehicles wherein there are two alternative sources of primary thermal fluid, one being driven by the vehicle engine and the other by an electrical source separate from the vehicle, but both using the same secondary thermal fluid, operable under a lower pressure and being water based. Each of the primary fluids is alternatively connectable to a heat exchanger receiving the secondary fluid. The secondary fluid is connected to one or more fluid to air heat exchangers spaced as desired in the passenger compartment and to any internal container or constant temperature box heat exchangers, such as a refrigerator, as desired within the compartment. This invention permits use of modular components mounted from the exterior of the vehicle. Various fluid flow directional valves can be used as desired for flexibility in temperature orientation.

Other objects, advantages and novel features of the present invention will now become readily apparent to those skilled in the art from the following drawings and detailed description of preferred embodiments.

### BRIEF DESCRIPTION OF THE DRAWINGS

FIG. 1 shows a schematic view of a preferred embodiment of the present invention

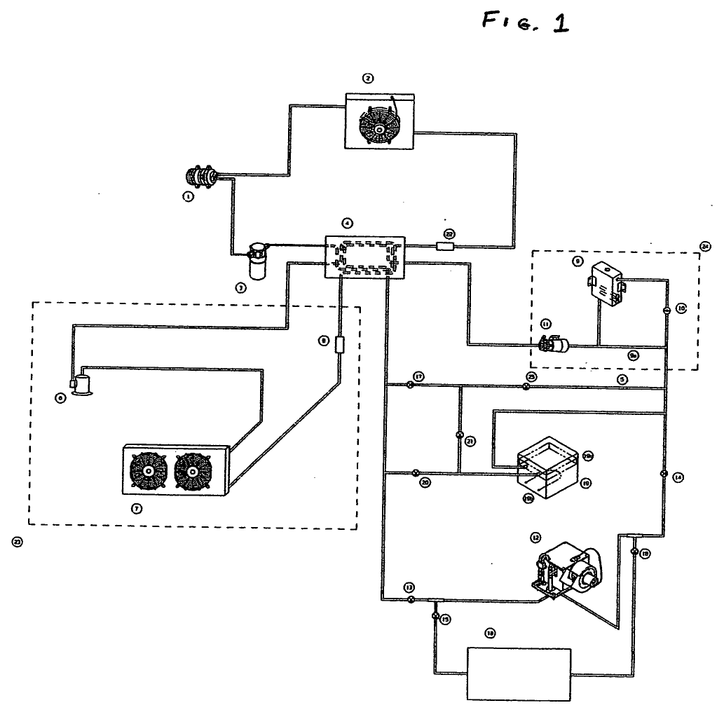

FIG. 2 shows a modular schematic view of the embodiment of the present invention of FIG. 1.

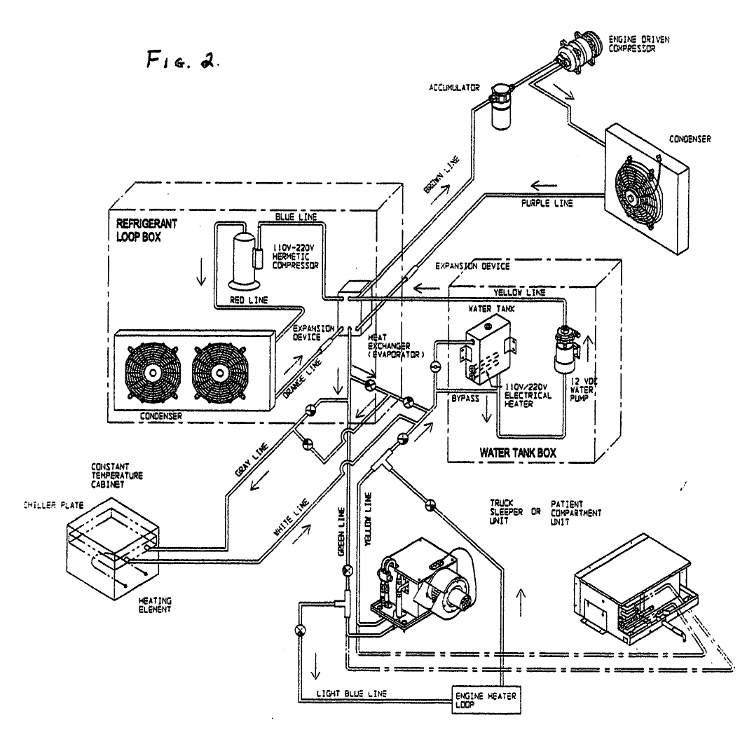

### DETAILED DESCRIPTION OF THE PREFERRED EMBODIMENTS

The drawings show schematically preferred embodiments of the present invention as mounted on a motor vehicle such as a truck cab. The component descriptions in the drawings for each numbered component are as follows: 1—engine driven compressor, 2—OWM or main loop remote condenser, 3—accumulator, 4—heat exchanger (three liquid chiller), 5—bypass, 6—electrical 110 v/220 v compressor, 7—remote condenser, 8—expansion device, 9—water/glycol tank with water heater, 9a—bypass, 10—metering valve, 11—12 v DC water pump, 13—normally open valve, 14—normally open valve, 15—OEM normally closed valve, 16—OEM normally closed valve, 17—normally closed valve, 18—engine heater loop, 19—constant temperature cabinet with chiller plate (19a) and heating element (19b), 20—normally open valve, 21—normally closed valve, 22—expansion device, 23—refrigerant loop box, 24—water tank box, 25—normally closed valve. The additional component descriptions in the drawings are incorporated herein by reference.

Typical fluid flow directions are indicated by the arrows adjacent to the fluid flow lines in the drawings. The engine driven compressor (conventional in nature and standard with most vehicles), refrigerant loop box, water tank box are all preferably mounted on the exterior of the occupant compartment or cab. Electricity for the 110 v compressor is, for example, provided from a source separate from the vehicle, as via an electrical extension cord. The system is illustrated for coolant, but can be alternatively run for heat. Each component is mounted as a modular unit, so that any number of modules can be added, replaced and used as desired. Except for the fluid to air heat exchangers and blowers and the constant temperature cabinet (refrigerator, for example), it is generally preferred to have all components mounted on the exterior of the occupant compartment or cab.

The valves are arranged to provide maximum operational efficiency. For example, the water tank, acting as a reservoir, can be bypassed during start-up operation to allow thermal treatment of the air to occur sooner. Various conventional sensors and/or timers can be included to monitor internal air temperature or secondary fluid temperature to control valve operation to this effect and to allow the passenger compartment to have a different temperature from the constant temperature cabinet. The secondary fluid is, for example, a water based fluid or water gycol mixture or similar non-toxic fluid.

Additional electrical heating elements can be used, for example, in the constant temperature compartment and/or the water tank to provide supplemental fluid temperature regulation as needed. These structure of these heating elements is preferably conventional in nature.

In general, the present invention uses two sources of primary thermal fluid alternatively (from the engine driven compressor or from the hermetic compressor) to heat or cool an operational secondary fluid. Heat exchangers are used rather than a refrigerant-to-air evaporator in the cooling mode of operation. The present invention reduces refrigerant leakage by not requiring a highly pressurized refrigerant fluid (on a rough order of magnitude, allowing a drop in pressure from 200 psi to 40 psi). Using smaller fluid tubes of the present invention takes up less space that conventional air ducts within the passenger compartment. The modular construction mounted outside of the passenger compartment allows less expensive installation and servicing of the system.

Although the present invention has been described above and shown in the drawings with respect to certain preferred embodiments, that is done by way of illustration and example only. Those persons or ordinary skill in the relevant and technology art will readily understand now from this disclosure that many variations can be made of the subject invention. For example, instead of using this invention to both heat and cool a vehicle, the primary/secondary fluid arrangement of the present invention could be used only for refrigeration or cooling of the vehicle while electrical heating of water in only the secondary loop could be used for the vehicle heating mode. Another variation of the present invention would be to use only a single primary fluid loop, such as for refrigeration or cooling, and omit use of the alternative primary fluid loop. Accordingly, the spirit and scope of the present invention are limited only by the terms of the following claims as ultimately allowed.

What is claimed is:

1. A system for heating and cooling a vehicle having a passenger compartment both during vehicle movement and when the vehicle is parked, comprising:
a. two alternative sources of primary thermal fluid, a first being driven by the vehicle motor and a second being driven by an electrical source separate from the vehicle motor such that when the vehicle is parked the vehicle motor can be shut off,
b. the primary thermal fluids being a source of relative heat or cold compared to the passenger compartment of the vehicle,
c. a secondary thermal fluid loop having at least:
d. a secondary fluid in liquid form and operable under lower fluid pressure than the primary thermal fluids,
e. a fluid to liquid first heat exchanging chamber for receiving at least one of the primary thermal fluids and the secondary fluid,
f. a liquid to air second heat exchanging chamber for receiving the secondary fluid and providing a source of thermally treated air,
g. a reservoir to retain a supply of secondary fluid,
h. conduit circuit connecting the first and second chambers and the reservoir, and
i. a valve arrangement connected to the conduit in the conduit circuit to permit one or more portions of the conduit circuit to be bypassed or isolated from other portions of the fluid circuit.

2. The system according to claim 1 wherein the sources of primary thermal fluid include a refrigerant fluid with an evaporator in those systems.

3. The system according to claim 1 wherein the sources of primary thermal fluids are located outside of the passenger compartment.

4. The system according to claim 1 wherein the secondary thermal fluid loop includes a pump located outside of the passenger compartment.

5. The system according to claim 1 wherein the valve arrangement allows the reservoir to be bypassed by the flow of liquid between the first and second chambers during initial operation of the vehicle motor such that the passenger compartment receives thermally treated air more quickly.

6. The system according to claim 5 wherein the reservoir bypass function is controlled according to the temperature of the liquid in the second thermal fluid loop by a temperature sensing device.

7. The system according to claim 1 wherein the secondary thermal fluid loop includes an isolated thermal compartment within the passenger compartment and the conduit circuit connects at least one of the first and second chambers or the reservoir to that isolated thermal compartment and the valve arrangement permits the isolated thermal compartment to maintain an internal temperature different from the temperature in the passenger compartment.

8. The system according to claim 7 wherein the secondary thermal fluid loop includes an additional fluid to fluid heat exchanging chamber such that sources of relative cold can be used within the secondary thermal fluid loop simultaneously.

9. The system according to claim 8 wherein the valve arrangement permits the isolated thermal compartment to receive liquid which is a source of relative cold while the second chamber receives liquid that is a source of relative heat.

10. The system according to claim 7 wherein the isolated thermal compartment includes a separately controllable heating element for temperature variation.

11. The system according to claim 1 wherein the secondary thermal fluid loop is connected to the vehicle motor to provide relative heat prior to starting the motor.

12. The system according to claim 11 wherein the valve arrangement allows either or both of the second chamber and reservoir to be isolated from the first chamber during initial operation of the motor.

13. The system according to claim 1 wherein a plurality of second chambers are provided and selectively connectable by the conduit circuit with the liquid arriving from the first chamber.

14. The system according to claim 1 where the secondary thermal fluid is water or a water glycol mixture.

15. The system according to claim 14 where in the first chamber receives conduits containing the primary thermal fluids and the secondary thermal fluid surrounds those conduits.

16. A system for cooling a vehicle having a passenger compartment, comprising:
a. a source of primary thermal fluid being driven by the vehicle motor,
b. the primary thermal fluid being a source of relative cold compared to the passenger compartment of the vehicle,
c. a secondary thermal fluid loop having at least:
d. a secondary fluid in liquid form and operable under lower fluid pressure than the primary thermal fluid,
e. a fluid to liquid first heat exchanging chamber for receiving the primary thermal fluid and the secondary fluid,
f. a liquid to air second heat exchanging chamber for receiving the secondary fluid and providing a source of thermally treated air,
g. a reservoir to retain a supply of secondary fluid,
h. conduit circuit connecting the first and second chambers and the reservoir, and
i. a valve arrangement connected to the conduit in the conduit circuit to permit one or more portions of the conduit circuit to be bypassed or isolated from other portions of the fluid circuit.
